(19) United States
(12) Patent Application Publication
(10) Pub. No.: US 2005/0205134 A1
(43) Pub. Date: Sep. 22, 2005

(54) Valve housing, cover, seal and method

(75) Inventors: Raymond E. Cellemme, Matthews, NC (US); William W. Sitton, Charlotte, NC (US)

Correspondence Address: Adams Evans P.A., 2180 Two Wachovia Center, 301 S. Tryon Street, Charlotte, NC, 28282, US

(73) Assignee: Conbraco Industries Inc., Matthews, NC (US)

(21) Appl. No.: 10/804,626

(22) Filed: Mar. 19, 2004

(51) Int. Cl. F16K 15/00

(52) U.S. Cl. 137/512

(57) ABSTRACT

A cover seal system for a valve housing with an access port, such as those found on backflow prevention devices. The invention generally includes a generally U-shaped gasket positioned on a peripheral edge of an access port located in a lateral wall of a valve housing and an arcuate cover for closing the access port. The geometry of the arcuate cover creates a clamping force which is more uniform across a surface of the gasket enabling the cover to seal at an elevated test pressure. The gasket is made relatively hard to prevent extrusion from the joint between the valve housing and the cover under elevated pressures.

### TECHNICAL FIELD AND BACKGROUND OF THE INVENTION

This invention relates to a cover seal system for a valve housing with an access port, such as those found on backflow prevention devices, and a method for installing the cover seal system.

Backflow prevention devices are required by most municipalities and water purveyors to prevent contamination of potable water supplies. Several agencies, whose approval may be mandated by the municipalities or water purveyors, impose requirements upon the design and function of backflow prevention devices.

One requirement imposed upon these devices is that their internal mechanisms can be removed, repaired, or inspected without removing the body of the device from the piping system. This, in turn, requires that the backflow prevention device be equipped with isolation shutoff valves and an access port large enough to allow the removal and reinstallation of the internal mechanism. When the backflow prevention device is in use, this opening must be completely and reliably sealed to prevent any leakage from the device.

A second requirement imposed upon the device is that it must withstand test pressures far in excess of its operating pressure without leaking. This requirement, in combination with the relatively large size of the opening, creates high forces and a difficult sealing situation.

The present invention addresses the sealing problems, under high pressure, associated with large access ports by utilizing a specially-shaped elastomeric gasket, to provide an effective seal, in combination with a cover fastened to the valve housing with fasteners.

### SUMMARY OF THE INVENTION

Therefore, it is an object of the invention to provide a specially-shaped elastomeric gasket for providing an effective seal.

It is another object of the invention to provide an elastomeric gasket with an elastomer hardness sufficient to provide effective sealing.

It is another object of the invention to provide a valve housing with an access port for removal and reinstallation of an internal mechanism.

It is another object of the invention to provide a cover designed to close the access port in the valve housing.

It is another object of the invention to provide a cover with a geometry that creates clamping forces which are more uniform.

These and other objects of the present invention are achieved in the preferred embodiments disclosed below by providing a backflow prevention apparatus, including a valve housing having an access port for removal and reinstallation of an internal mechanism without the removal of the valve housing from a piping system; an arcuate cover for closing the access port; an endless resilient gasket for providing a seal between the cover and the valve housing, comprising a web and a pair of legs, wherein the web connects the legs to form a generally U-shaped cross-section, the gasket being positioned on a peripheral edge of the access port, with the web positioned adjacent to the peripheral edge and the legs positioned on opposite sides of the peripheral edge in sealing contact with the cover and the valve housing; and a fastener for clamping the cover to the valve housing, wherein the cover is shaped to provide a substantially uniform clamping force to the gasket.

According to another preferred embodiment of the invention, the cover has at least one cover flange for clamping to a mating valve housing flange disposed on the valve housing.

According to another preferred embodiment of the invention, the cover and valve housing are connected by at least one hinge for permitting the cover to move away from and into contact with the resilient gasket.

According to another preferred embodiment of the invention, the fastener comprises at least one bolt extending through a hole in the cover flange and a corresponding hole in the valve housing flange.

According to another preferred embodiment of the invention, the web has a thickness greater than a thickness of the legs to prevent the gasket from extruding outward between the valve housing and the cover when the cover is attached to the valve housing.

According to another preferred embodiment of the invention, the gasket has an elastomer hardness of about 70 durometer to about 90 durometer on a Shore A scale.

According to another preferred embodiment of the invention, the gasket has an elastomer hardness of about 80 durometer on a Shore A scale.

According to another preferred embodiment of the invention, a backflow prevention apparatus, including a cylindrical valve housing having an access port in a peripheral surface thereof for removal and reinstallation of an internal mechanism without the removal of the valve housing from a piping system; an arcuate cover having a pair of spaced apart cover flanges for closing the access port, wherein the cover flanges are spaced apart by a first width; an endless resilient gasket for providing a seal between the cover and the valve housing, comprising a web and a pair of legs, wherein the web connects the legs to form a generally U-shaped cross-section, the gasket being positioned on a peripheral edge of the access port, such that the web is positioned adjacent to the peripheral edge and the legs are positioned on opposite sides of the peripheral edge in sealing contact with the cover and the valve housing; a pair of spaced apart valve housing flanges carried by the cylindrical valve housing being spaced apart by a second width, wherein the first width is greater than the second width; and a fastener for clamping the cover flanges to the corresponding valve housing flanges.

According to another preferred embodiment of the invention, the cover has a height measured from the cover flange to a top centerline of the cover, the first width being greater than the height.

According to another preferred embodiment of the invention, the cover has a height being measured from the cover flange to a top centerline of the cover, the first width being greater than the height.

According to another preferred embodiment of the invention, the web has a thickness greater than a thickness of the legs to prevent the gasket from extruding outward between the valve housing and the cover when the cover is attached to the valve housing.

According to another preferred embodiment of the invention, the gasket has an elastomer hardness of about 70 durometer to about 90 durometer on a Shore A scale.

According to another preferred embodiment of the invention, the gasket has an elastomer hardness of about 80 durometer on a Shore A scale.

According to another preferred embodiment of the invention, the method of installing a cover seal system, includes the steps of providing a valve housing having an access port for removal and reinstallation of an internal mechanism without the removal of the valve housing from a piping system; providing an arcuate cover for closing the access port; providing an endless resilient gasket for providing a seal between the cover and the valve housing, comprising a web and a pair of legs, wherein the web connects the legs to form a generally U-shaped cross-section, the gasket being positioned on a peripheral edge of the access port, such that the web is positioned adjacent to the peripheral edge and the legs are positioned on opposite sides of the peripheral edge in sealing contact with the cover and the valve housing; and clamping the cover to the valve housing using a fastener, wherein the cover is shaped to provide a substantially uniform clamping force to the gasket.

According to another preferred embodiment of the invention, clamping the cover to the valve housing includes the steps of positioning the cover over the access port and resilient gasket; mating a cover flange to a mating valve housing flange; and fastening the cover flange to the mating valve housing flange using the fastener.

According to another preferred embodiment of the invention, an endless resilient gasket for a backflow prevention apparatus having a valve housing with an access port in a peripheral surface thereof for removal and reinstallation of an internal mechanism and an arcuate cover for closing the access port, the resilient gasket includes a web having a first thickness; and a pair of outwardly projecting legs each having a second thickness, wherein the legs are connected by the web forming a generally U-shaped cross-section, the U-shaped cross-section permitting the gasket to straddle a peripheral edge of the access port in sealing contact with the cover and the valve housing.

According to another preferred embodiment of the invention, the first thickness is greater than the second thickness to prevent the gasket from extruding outward between a valve housing and a cover when the cover is attached to the valve housing.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 shows a vertical cross-sectional view of a valve housing with an access port being sealed by a gasket, cover, and fasteners according to the present invention.

FIG. 2 shows a perspective view of a valve housing with an access port.

FIG. 3 shows a perspective view of the valve access port cover.

FIG. 4 shows a perspective view of the elastomer gasket.

FIG. 5 shows a cross sectional view of the elastomer gasket.

FIG. 6 shows a perspective view of the valve housing with an elastomer gasket installed on the access port.

FIG. 7 shows a vertical cross-sectional view of an alternative embodiment of a valve housing with an access port being sealed by a gasket, cover, and fasteners according to the present invention.

### DESCRIPTION OF THE PREFERRED EMBODIMENT AND BEST MODE

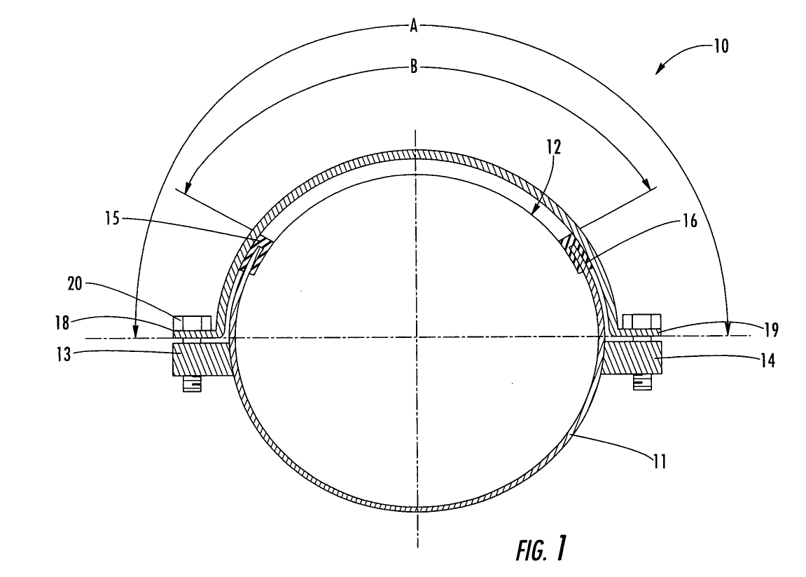

Referring now specifically to the drawings, a backflow prevention device assembly according to a preferred embodiment of the present invention is illustrated in FIG. 1 and shown generally at reference numeral 10. The present invention generally comprises a cylindrical valve housing 11 having an access port 12 therein and a pair of valve housing flanges 13 and 14 located on opposite sides of the valve housing 180 degrees apart along a horizontal centerline of the valve housing 11. The valve housing 11 has internal mechanisms (not shown), such as poppet valves, mounted inside.

A resilient gasket 15 is used to provide a seal between the valve housing 11 and an arcuate access port cover 16 preventing any leakage from the valve housing 11. The cover 16 has a pair of cover flanges 18 and 19 which are used to fasten the cover 16 to the valve housing 11 through the use of fasteners 20 which extend through the cover flanges 18 and 19 and the corresponding valve housing flanges 13 and 14 to provide a clamping force.

The arcuate access port cover 16 has an arc length A of about 180 degrees to insure coverage and sealing of the access port 12 at high pressures. The arc length A of the cover 16 must be large enough to cover the access port 12 and provide adequate sealing. The access port 12, having an arc length B, allows the removal of the internal mechanisms for repair or inspection without removing the valve housing 11 from a piping system. The arc length B is restricted to an arc length less than 180 degrees, preferably between 150 and 160 degrees, to allow a clamping force, generated by the fasteners 20 and cover 16, large enough to provide sealing at a high test pressure. If the arc length B is extended to a point at or near a horizontal centerline of the valve housing 11, the clamping force generated by the fasteners 20 and cover 16 will be very small and will not provide adequate sealing at high test pressures. Thus, the access port 12 can only be enlarged by extending the access port 12 axially along the central axis of the valve housing 11 due to the arc length limitations set forth above.

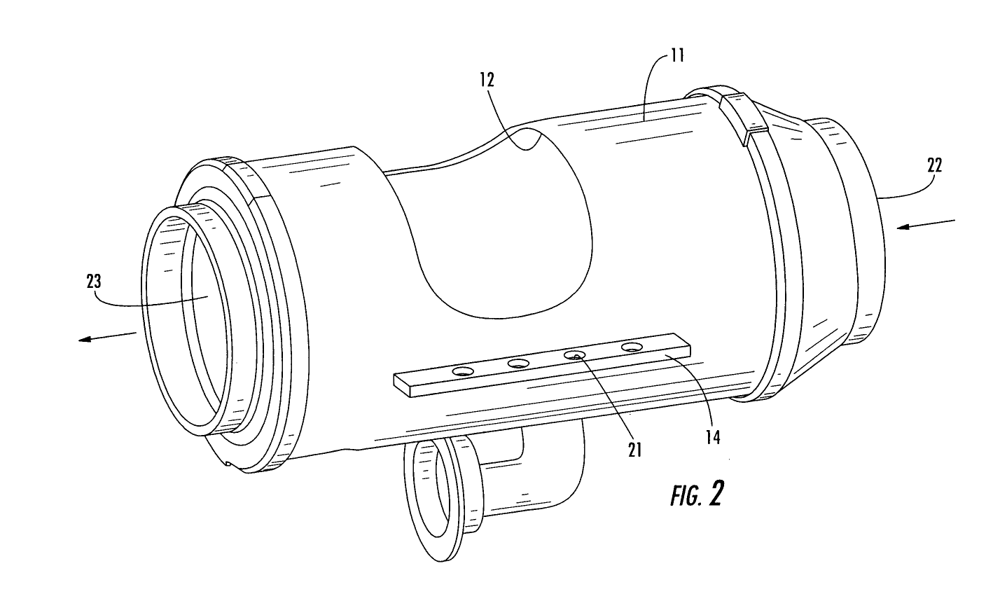

Referring now to FIG. 2, the access port 12 located in a peripheral wall of the valve housing 11 is a “canoe” shaped access opening (i.e. a rectilinearly shaped opening having radiused corners superimposed on the cylindrical valve housing). The valve housing 11 has an inlet port 22 and an outlet port 23 to allow the flow of liquid through the valve housing 11. The valve housing flanges 13 and 14 located on opposite sides of the valve housing 11 have a plurality of holes 21 to allow the fasteners 20 to extend through the holes 21 and provide a clamping force.

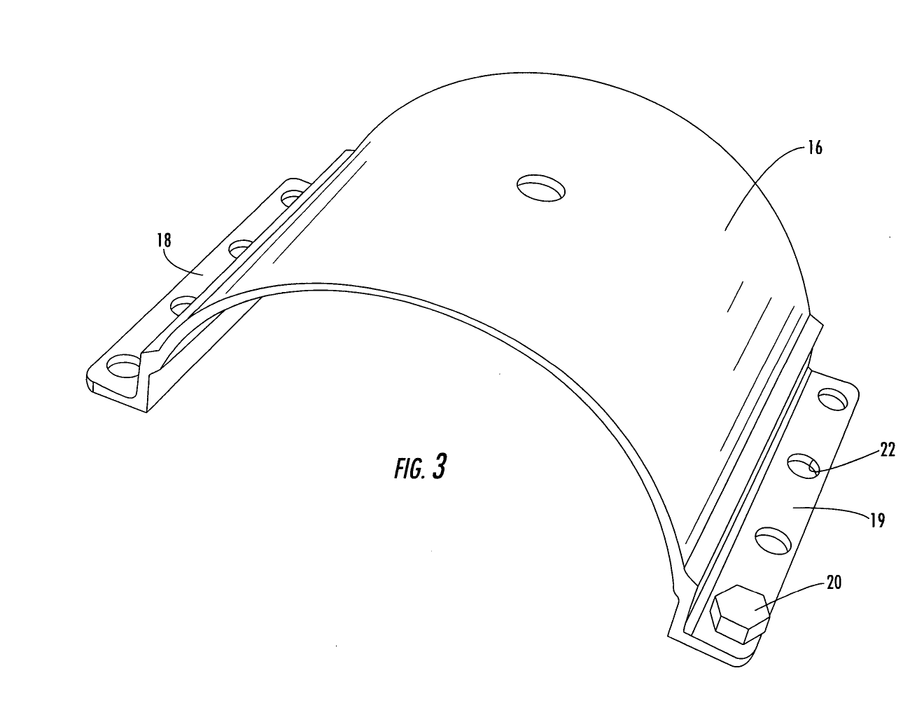

Referring now to FIG. 3, the arcuate access port cover 16 has a pair of cover flanges 18 and 19. The cover flanges 18 and 19 have a plurality of holes 21 to allow the fasteners 20 to extend through the holes 22 and provide a clamping force. The cover 16 is formed in an oval, rather than cylindrical, shape. The width of the cover is greater than two times the height of the cover. The width is measured from cover flange 18 located at one extreme end of the cover to cover flange 19 located at an opposite extreme end of the cover. The height is measured from a bottom of the cover to a top of the cover located at the top centerline.

When the cover 16 is in its free state (no clamping forces applied), its centerline contacts the gasket 15 at a top centerline of the access port 12 in the valve housing 11, and does not contact the gasket 15 at an end of the cover 16. As the fasteners 20 are tightened, the clamping force is first applied at the top centerline of the cover 16, and then applied progressively toward the ends of the cover 16. This geometry creates a clamping force which is more uniform across a surface of the gasket 15, enabling the cover 16 to seal at an elevated test pressure.

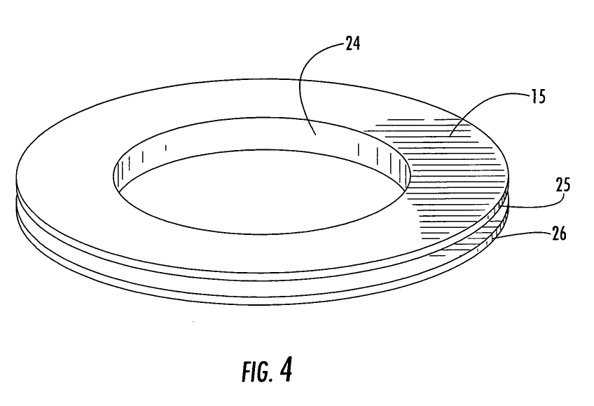

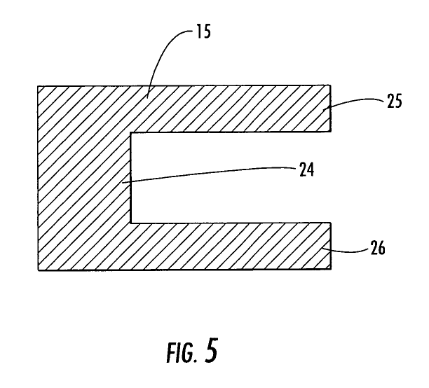

Referring now to FIGS. 4, 5, and 6, the resilient gasket 15 is used to provide an effective seal between the cover 16 and the valve housing 11. Prior designs consist of simple flat gaskets or a sealant. As is shown in FIG. 5, the gasket 15 has a generally C-shaped or U-shaped cross-section including a web 24 and two legs 25 and 26. As is shown in FIG. 4, the gasket 15 is endless and circular in an uninstalled condition, with the legs 25 and 26 facing outwards. The gasket 15 is made of a relatively hard rubber or synthetic elastomer, for example between 70-90 durometer on the Shore “A” scale, so that it will not be extruded from the joint at high pressures. Preferably, the gasket 15 will have a hardness of 80 durometer on the Shore “A” scale.

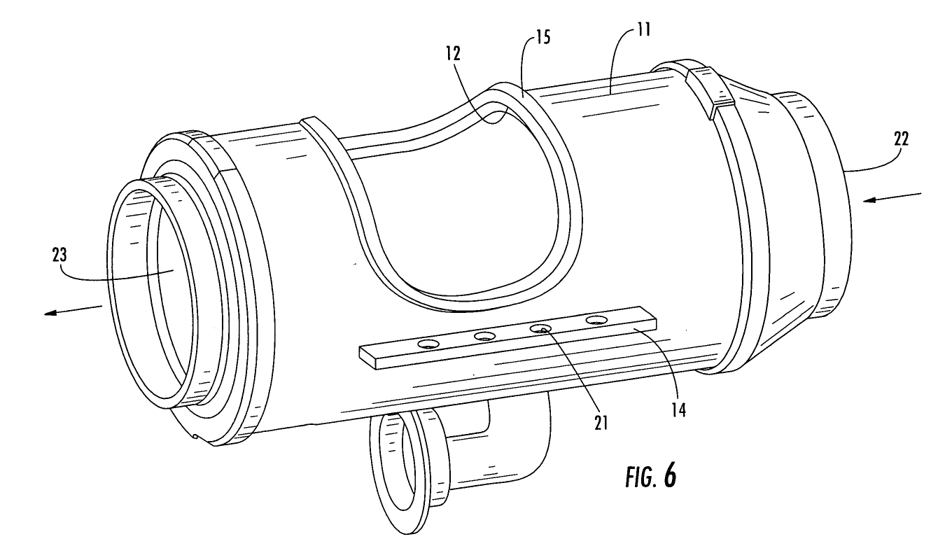

The web 24 of the gasket 15 is made thicker than the leg that is clamped between the cover 16 and the valve housing 11, to prevent an internal pressure from extruding the gasket 15 outward between the valve housing 11 and the cover 16. As is shown in FIG. 6, the gasket 15 is installed by placing the gasket 15 over a peripheral edge of the access port 12. The gasket is positioned so that the web 24 resides adjacent to the peripheral edge of the access port 12. The legs 25 and 26 straddle the peripheral edge positioning the legs 25 and 26 on opposite sides of the peripheral edge.

Once the gasket 15 is installed, the cover 16 can be fastened to the valve housing 11 to provide an adequate seal. In the event that maintenance is performed on the backflow prevention device 10, the cover 16 can be removed without removing the gasket 15. The gasket 15 remains in place on the peripheral edge of the valve housing 11 without the use of an adhesive or sealant.

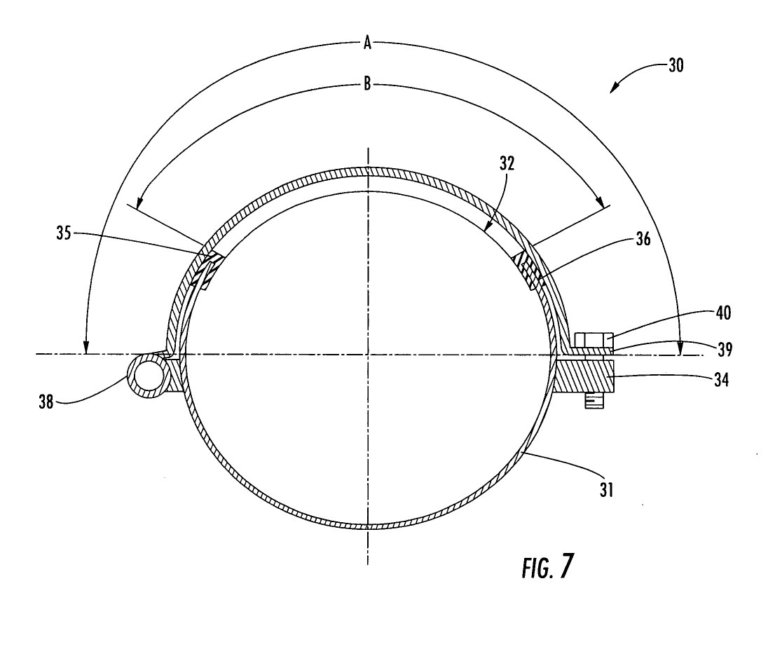

Alternatively, as shown in FIG. 7, a second embodiment of the invention shown generally by reference numeral 30, includes all of the features of the first embodiment except the second embodiment utilizes a hinge in place of one of the spaced apart flanges. In this embodiment of the invention, an access port cover 36 may be attached to a valve housing 31 via a piano hinge 38 or any other suitable hinge. The cover 36 is hinged to the valve housing 31 allowing access to an access port 32 without detaching the cover 36 from the valve housing 31. The cover is then fastened to the valve housing 31 via corresponding flanges 34 and 39 located opposite of the piano hinge 38. Fasteners 40 provide the clamping force needed for adequate sealing.

A valve housing, cover, seal, and method is described above. Various details of the invention may be changed without departing from its scope. Furthermore, the foregoing description of the preferred embodiments of the invention and the best mode for practicing the invention are provided for the purpose of illustration only and not for the purpose of limitation, the invention being identified in the claims.

1. A backflow prevention apparatus, comprising:
(a) a valve housing having an access port for removal and reinstallation of an internal mechanism without the removal of the valve housing from a piping system;
(b) an arcuate cover for closing the access port;
(c) an endless resilient gasket for providing a seal between the cover and the valve housing, comprising a gasket web and a pair of legs, wherein the gasket web connects the legs to form a generally U-shaped cross-section, the gasket being positioned on a peripheral edge of the access port, with the gasket web positioned adjacent to the peripheral edge and the legs positioned on opposite sides of the peripheral edge in sealing contact with the cover and the valve housing; and
(d) a fastener for clamping the cover to the valve housing, wherein the cover is shaped to provide a substantially uniform clamping force to the gasket.

2. The backflow prevention apparatus according to claim 1, wherein the cover has at least one cover flange for clamping to a mating valve housing flange disposed on the valve housing.

3. The backflow prevention apparatus according to claim 1, wherein the cover and valve housing are connected by at least one hinge for permitting the cover to move away from and into contact with the resilient gasket.

4. The backflow prevention apparatus according to claim 2, wherein the fastener comprises at least one bolt extending through a hole in the cover flange and a corresponding hole in the valve housing flange.

5. The backflow prevention apparatus according to claim 1, wherein the gasket web has a thickness greater than a thickness of the legs to prevent the gasket from extruding outward between the valve housing and the cover when the cover is attached to the valve housing.

6. The backflow prevention apparatus according to claim 1, wherein the gasket has an elastomer hardness of about 70 durometer to about 90 durometer on a Shore A scale.

7. The backflow prevention apparatus according to claim 1, wherein the gasket has an elastomer hardness of about 80 durometer on a Shore A scale.

8. A backflow prevention apparatus, comprising:
(a) a cylindrical valve housing having an access port in a peripheral surface thereof for removal and reinstallation of an internal mechanism without the removal of the valve housing from a piping system;
(b) an arcuate cover having a pair of spaced apart cover flanges for closing the access port, wherein the cover flanges are spaced apart by a first width;
(c) an endless resilient gasket for providing a seal between the cover and the valve housing, comprising a web and a pair of legs, wherein the web connects the legs to form a generally U-shaped cross-section, the gasket being positioned on a peripheral edge of the access port, such that the web is positioned adjacent to the peripheral edge and the legs are positioned on opposite sides of the peripheral edge in sealing contact with the cover and the valve housing;
(d) a pair of spaced apart valve housing flanges carried by the cylindrical valve housing being spaced apart by a second width, wherein the first width is greater than the second width; and
(e) a fastener for clamping the cover flanges to the corresponding valve housing flanges.

9. The backflow prevention apparatus according to claim 8, wherein the cover has a height measured from the cover flange to a top centerline of the cover, the first width being greater than the height.

10. The backflow prevention apparatus according to claim 8, wherein the fastener comprises at least one bolt extending through a hole in the cover flange and a corresponding hole in the valve housing flange.

11. The backflow prevention apparatus according to claim 8, wherein the web has a thickness greater than a thickness of the legs to prevent the gasket from extruding outward between the valve housing and the cover when the cover is attached to the valve housing.

12. The backflow prevention apparatus according to claim 8, wherein the gasket has an elastomer hardness of about 70 durometer to about 90 durometer on a Shore A scale.

13. The backflow prevention apparatus according to claim 8, wherein the gasket has an elastomer hardness of about 80 durometer on a Shore A scale.

14. The method of installing a cover seal system, comprising the steps of:
(a) providing a valve housing having an access port for removal and reinstallation of an internal mechanism without the removal of the valve housing from a piping system;
(b) providing an arcuate cover for closing the access port;
(c) providing an endless resilient gasket for providing a seal between the cover and the valve housing, comprising a web and a pair of legs, wherein the web connects the legs to form a generally U-shaped cross-section, the gasket being positioned on a peripheral edge of the access port, such that the web is positioned adjacent to the peripheral edge and the legs are positioned on opposite sides of the peripheral edge in sealing contact with the cover and the valve housing; and
(d) clamping the cover to the valve housing using a fastener, wherein the cover is shaped to provide a substantially uniform clamping force to the gasket.

15. The method according to claim 14, wherein clamping the cover to the valve housing comprises the steps of:
(a) positioning the cover over the access port and resilient gasket;
(b) mating a cover flange to a mating valve housing flange; and
(c) fastening the cover flange to the mating valve housing flange using the fastener.

16. An endless resilient gasket for a backflow prevention apparatus having a valve housing with an access port in a peripheral surface thereof for removal and reinstallation of an internal mechanism and an arcuate cover for closing the access port, the resilient gasket comprising:
(a) a web having a first thickness; and
(b) a pair of outwardly projecting legs each having a second thickness, wherein the legs are connected by the web to form a generally U-shaped cross-section, the U-shaped cross-section permitting the gasket to straddle a peripheral edge of the access port in sealing contact with the cover and the valve housing.

17. The endless resilient gasket according to claim 16, wherein the first thickness is greater than the second thickness to prevent the gasket from extruding outward between a valve housing and a cover when the cover is attached to the valve housing.
